(19) United States
(12) Patent Application Publication
(10) Pub. No.: US 2024/0209138 A1
(43) Pub. Date: Jun. 27, 2024

(54) PRODUCTION OF HARD POLYURETHANE OR POLYISOCYANURATE FOAM

(71) Applicant: Evonik Operations GmbH, Essen (DE)

(72) Inventors: Martin GLOS, Borken (DE); Jobst Grimminger, Ellerau (DE)

(73) Assignee: Evonik Operations GmbH, Essen (DE)

(21) Appl. No.: 18/554,954

(22) PCT Filed: Mar. 22, 2022
(86) PCT No.: PCT/EP2022/057460

§ 371 Date: Oct. 11, 2023

(30) Foreign Application Priority Data
Apr. 14, 2021 (EP) 21168269.5

(51) Int. Cl. C08G 18/22; C08G 18/16; C08G 18/42; C08G 18/48

(52) U.S. Cl. CPC C08G 18/222; C08G 18/163; C08G 18/4208; C08G 18/48; C08G 2110/0025

(57) ABSTRACT

A composition for production of rigid polyurethane or polyisocyanurate foam contains at least an isocyanate component, a polyol component, optionally a foam stabilizer, optionally a blowing agent, and at least one catalyst that catalyzes the formation of a urethane or isocyanurate bond. The catalyst contains zinc salts and/or a zinc-containing formulation.

The present invention is in the field of polyurethanes (PU) and polyisocyanurates (PIR), especially of rigid PU or PIR foams. More particularly, it relates to the production of rigid PU or PIR foams using zinc salts, and additionally to the use of the foams which have been produced therewith. The present invention concerns rigid PU or PIR foams.

Polyurethane (PU) in the context of the present invention is especially understood to mean a product obtainable by reaction of polyisocyanates and polyols or compounds having isocyanate-reactive groups. Further functional groups in addition to the polyurethane may also be formed in the reaction, for example uretdiones, carbodiimides, isocyanurates, allophanates, biurets, ureas and/or uretonimines. PU is therefore for the purposes of the present invention understood as meaning not just polyurethane, but also polyisocyanurate, polyureas, and polyisocyanate reaction products containing uretdione, carbodimide, allophanate, biuret and uretonimine groups. In the context of the present invention, polyurethane foam (PU foam) Is especially understood to mean foam which is obtained as reaction product based on polyisocyanates and polyols or compounds having isocyanate-reactive groups. In addition to the eponymous polyurethane, further functional groups can be formed as well, examples being allophanates, biurets, ureas, carbodiimides, uretdiones, isocyanurates or uretonimines.

The present invention more particularly concerns the formation of polyisocyanurates. This reaction is referred to as trimerization since, in a formal sense, three isocyanate groups react to give an isocyanurate ring. The production of rigid PIR foam is described in the literature and is typically effected by reacting polyisocyanates with compounds having hydrogen atoms reactive toward isocyanate groups, usually polyetherols, polyesterols or both, where the isocyanate index is preferably 180 or greater. In addition to the urethane structures formed by the reaction of isocyanates with compounds having reactive hydrogen atoms, this results in formation, via reaction of the isocyanate groups with one another, of isocyanurate structures or further structures that result from the reaction of isocyanate groups with other groups, for example polyurethane groups.

In the production of rigid polyurethane and polyisocyanurate foams, various catalysts are used in order to positively influence the reaction profile of the foaming and the use properties of the foam. The formation of polyisocyanurates is advantageous here since these lead to good mechanical properties (high compression hardness) and improved flame-retardant properties.

There are various known publications relating to the use of catalysts for improvement of compression hardness by promoting the trimerization reaction in the production of rigid PU or PIR foams.

EP 1878493 A1 describes the use of carbocationic compounds as polymerization catalyst, where the anions are based on dicarbonyl compounds. There is no description of the use of zinc carboxylates. U.S. Pat. No. 4,452,829 describes the production of spray foam using triols having molar masses exceeding 1000 g/mol. Zn salts are used in combination here with K salts in order to accelerate creaming, i.e. the start of the PU reaction with water. A Zn-containing catalyst (zinc octoate) is also added to a K-containing catalyst in order to shorten the cream time, i.e. to accelerate the reaction.

U.S. Pat. No. 4,200,699 describes gel catalyst compositions for the production of rigid PU foams containing zinc carboxylates, potassium carboxylates and antimony carboxylates, preferably with use of a further gel catalyst from the group of the tertiary amines, the inorganic tin compounds or the organotin compounds.

EP 1 745 847 A1 describes trimerization catalysts based on potassium oxalate and solvents that are inert with respect to the reaction with isocyanates.

WO 2016/201675 describes trimerization catalysts consisting of compositions based on sterically hindered carboxylates and tertiary amines that bear an isocyanate-reactive group.

WO 2010/054317 describes iminium salts as trimerization catalysts.

WO 2013/074907 A1 describes the use of tetraalkylguanidine salts or aromatic carboxylic acids as catalysts for polyurethane foams.

The problem addressed by the present invention was that of enabling the provision of rigid polyurethane or polyisocyanurate foams that have particularly advantageous use properties, such as, in particular, good compression hardness and/or indentation hardness even after a short reaction time. At the same time, however, the influence on the rise profile was preferably to be minimized.

It has now been round that, surprisingly, the use of zinc salts and/or zinc-containing formulations enables the solution of this problem.

The present invention therefore provides a composition for production of rigid polyurethane or polyisocyanurate foam, comprising at least an isocyanate component, a polyol component, optionally a foam stabilizer, optionally blowing agent, wherein said composition contains at least one catalyst that catalyses the formation of a urethane or isocyanurate bond, and wherein said catalyst comprises zinc salts and/or a zinc-containing formulation.

A zinc-containing formulation in the context of this invention is a formulation containing zinc. A formulation in turn is a blend, mixture or solution consisting of two or more substances. A zinc-containing formulation in the context or this invention is thus a formulation containing zinc and at least one further constituent.

This zinc-containing formulation may comprise any desired further constituents, but preferably solvents and at least one nitrogen-containing compound.

Solvents and the at least one nitrogen-containing compound are described in more detail further down. A preferred zinc-containing formulation in the context of this invention thus comprises zinc salts, solvents and at least one nitrogen-containing compound, especially each as defined further down.

It has been found that the use of compositions according to the invention in the production of rigid PU or PIR foam leads to corresponding rigid foams having improved use properties. More particularly, trimerization is improved, as a result of which the foams cure more quickly, meaning that they have a high compression hardness and high indentation hardness at an early juncture. It is also a particular advantage of the present invention that the use of the compositions according to the invention nevertheless enables minimization of the influence on the rise profile. This is very advantageous since problems can otherwise occur with the flowability of the reaction mixture, which leads to considerable processing problems. With the compositions according to the invention, it is in some cases also possible to slow the rise profiles, which enables a wide variety of options for adjusting the reactivity of a foam system.

The effect that a PU reaction can be slowed by the addition of zinc-containing compounds is surprising and novel. According to prior art, zinc-containing compounds lead to acceleration of the reaction, i.e. to shorter cream times or gel times, as described, for example, in U.S. Pat. No. 442,829.

By the solution according to the invention, it is thus possible to produce rigid PU or PIR foam-based products, for example insulation panels or cooling units with very particularly high-quality, and to make the processes for production of the rigid PU or PIR foams more efficient.

An additional advantage of the invention is the good environmental toxicology classification of the chemicals usable, especially of the zinc salts or zinc-containing formulation. This is because it is often the case in the prior art that metal compounds having problematic toxicological properties are used (Sn, Pb, etc.).

The invention has the further advantage that it can help to produce rigid PU or PIR foams having a low level of foam defects.

In a preferred embodiment of the invention, the zinc salts and/or zinc-containing formulations comprise zinc(II) salts, preferably zinc(II) carboxylates, where the carboxylates are based on carboxylic acids containing 1 to 34 carbons, which may also contain unsaturated or aromatic units, especially comprising zinc(II) acetate, zinc(II) propionate, zinc(II) pivalate, zinc(II) 2-ethylhexanoate (zinc(II) octoate), zinc(II) isononanoate (zinc(II) 3,5,5-trimethylhexanoate), zinc(II) neodecanoate, zinc(II) ricinoleate, zinc(II) palmitate, zinc(II) stearate, zinc(II) oleate, zinc(II) laurate, zinc(II) naphthenate and/or zinc(II) benzoate, the most preferred being zinc(II) acetate and/or zinc(II) ricinoleate, and/or where the carboxylates may also have N and O as heteroatoms, especially comprising zinc(II) lactate, zinc(II) glycinate, zinc(II) hippurate and/or zinc(II) citrate, and/or zinc(II) soaps such as, in particular, zinc oleate, zinc palmitate and/or zinc stearate.

The compositions according to the invention preferably contain zinc carboxylates in stoichiometric form, i.e. Zn and carboxylate in a molar ratio of 1:2. i.e., more particularly, no excess of carboxylate or carboxylic acid. It is often the case in Industrial processes for preparing zinc salts that the parent acid is used in excess, such that the end product still contains an excess of the acid. This is not advantageous here.

The total use amount of the zinc salts is preferably in the range from 0.025% to 2% by weight, preferably 0.05% to 1.6% by weight, more preferably 0.1% to 1.2% by weight, based on the overall composition.

In the context of the present invention, it is very particularly preferable to introduce the zinc salts and/or zinc-containing formulation for use in PU or PIR reaction mixtures in dissolved form.

Therefore, in a preferred embodiment of the invention, the zinc salts according to the invention and/or zinc-containing formulation are added to the reaction mixture in a carrier medium, i.e. the zinc-containing formulation preferably comprises a carrier medium. The terms “carrier medium” and “solvent” are used synonymously in the context of the present invention.

More particularly, a preferred zinc-containing formulation comprises zinc salts, preferably zinc(II) salts, especially zinc(II) carboxylate, in a carrier medium, especially comprising glycols, alkoxylates and/or oils of synthetic and/or natural origin. This is a preferred embodiment of the invention.

In principle, carrier media used may be any substances suitable as solvent. Preferred examples include glycols, alkoxylates and/or oils of synthetic and/or natural origin. It is possible to use protic or aprotic solvents.

The zinc-containing formulations according to the invention may also be used as part of compositions with different carrier media.

The use of the carrier media is preferred in order to provide a zinc-containing formulation that can be used in an uncomplicated manner. Preference is given here to a minimum viscosity, such that the formulation does not make a specific demands on pumps or other technical equipment. Preferred viscosities are less than 10 Pa s, preferably less than 8 Pa-s, more preferably less than 6 Pa s, measured at 25° C. by the Höppler method described in DIN 53655.

In addition, it is very particularly preferable in the context of the present invention when the composition according to the invention additionally contains at least one nitrogen-containing compound. This can promote the solubility of the zinc salt in the respective carrier medium in an optimal manner. It is possible here with preference to use amines, amine alkoxylates, amino acids and/or amines having two or more acid functions, but especially N,N,N′,N′-tetrakis(2-hydroxypropyl)ethylenediamine, N,N,N′,N′-tetrakis(2-hydroxyethyl)ethylenediamine, 2-[[2-[2-(dimethylamino)ethoxy]ethyl]methylamino]ethanol, fatty amine ethoxylates, such as tallowamine ethoxylate, cocoamine ethoxylate, cetyl/stearylamine ethoxylate, PEG-3 tallowaminopropylamine, PPG-3 tallowaminopropylamine, glycine, lysine, arginine, sarcosine, ethylenediaminetetraacetate and/or ethylenediaminetriacetate cocoalkylacetamide, with fatty amine alkoxylates being usable with particular preference, where the at least one nitrogen-containing compound is especially present in the zinc-containing formulation. N,N,N′,N′-Tetrakis(2-hydroxypropyl)ethylenediamine and/or N,N,N′,N′-tetrakis(2-hydroxyethyl)ethylenediamine are most preferred.

These additionally usable nitrogen-containing compounds are preferably present in amounts of 0.01% to 3% by weight, preferably 0.02% to 2% by weight, more preferably 0.1% to 1.5%, based on the overall composition according to the invention.

A very particularly preferred zinc-containing formulation thus comprises
(a) zinc salt (preferably zinc(II) salt, especially zinc(II) carboxylate), especially as described above,
(b) carrier medium (especially comprising glycols, alkoxylates or oils of synthetic and/or natural origin) and
(c) nitrogen-containing compound, especially as described above, a particularly preferred nitrogen-containing compound being N,N,N′,N′-tetrakis(2-hydroxypropyl)ethylenediamine and/or N,N,N′,N′-tetrakis(2-hydroxyethyl)ethylenediamine.

In addition, in a preferred embodiment of the invention, the composition according to the invention additionally contains at least one additional trimerization catalyst. The additional trimerization catalysts as such do not themselves contain any zinc, but are added additionally in a preferred embodiment of the invention.

The additional trimerization catalysts can adjust the reaction rate to the desired degree if desired. The additional trimerization catalyst may also be a constituent of the zinc-containing formulation, which is a preferred embodiment. In another preferred embodiment, it is not a constituent of the zinc-containing formulation, but is supplied separately to the composition according to the invention.

It Is possible in principle to use any known trimerization catalysts. Particularly suitable additional trimerization catalysts are, for example, carboxylates of ammonium cations, for example tetramethylammonium, tetraethylammonium, tetrapropylammonium, tetrabutylammonium, dimethyldiallylammonium, trimethyl(2-hydroxypropyl)ammonium, triethyl(2-hydroxypropyl)ammonium, tripropyl(2-hydroxypropyl)ammonium, tributyl(2-hydroxypropyl)ammonium, trimethyl(2-hydroxyethyl)ammonium, triethyl(2-hydroxyethyl)ammonium, tripropyl(2-hydroxyethyl)ammonium, tributyl(2-hydroxyethyl)ammonium, dimethylbenzyl(2-hydroxyethyl)ammonium and/or dimethylbenzyl(2-hydroxypropyl)ammonium, or the like. Likewise useful as cations are potassium or other alkali metals or alkaline earth metals, especially as described in documents EP1 745 847 A1 and WO 2016/201675 and the citations present therein. Preference is given to using a potassium carboxylate, especially potassium acetate, potassium formate, potassium propionate, potassium butanoate, potassium pentanoate, potassium hexanoate, potassium heptanoate, potassium 2 ethylhexanoate, potassium pivalate, potassium octoate, potassium butyrate, potassium isobutyrate, potassium nonanoate, potassium decanoate, potassium ricinoleate, potassium stearate, and/or potassium neodecanoate.

A preferred composition according to the invention comprises additional trimerization catalysts in amounts of 0.2% to 9% by weight, preferably of 0.5% to 7% by weight, based on the overall composition according to the invention.

A preferred composition according to the invention thus comprises zinc salt (preferably zinc(II) salt, especially zinc(II) carboxylate), carrier medium, nitrogen-containing compound and optionally (preferably obligatorily), additional trimerization catalyst. It is preferable here that the optionally (preferably obligatorily) usable additional trimerization catalyst is not part of the zinc-containing formulation.

In addition, in a preferred embodiment of the invention, the compositions according to the invention are free of antimony carboxylates and/or tin carboxylates.

In a further preferred embodiment of the invention, the composition according to the invention additionally comprises tertiary amine (i.e. additional tertiary amine) as further catalysts, said additional tertiary amines preferably containing at least two nitrogen atoms per molecule.

Additional tertiary amines that are usable with particular preference are selected from group 1. This group 1 consists of the following amines: pentamethyldiethylenetriamine, bis(2-dimethylaminoethyl) ether, tris(dimethylaminopropyl)amine, N-[2-[2-(dimethylamino)ethoxy]ethyl]-N-methylpropane-1,3-diamine, 2-{[2-(dimethylamino)ethyl]methylamino}ethanol, 2-[[2-[2-(dimethyl-amino)ethoxy]ethyl]methylamino]ethanol, N-methyl-N—(N,N-dimethylaminopropyl)aminopropanol, N-methyl-N—(N,N-dimethylaminopropyl)aminoethanol, 1-bis[3-(dimethylamino)propyl]amino]-2-propanol, 1,1′[[3-(dimethylamino)propyl]amino]-2-propanol, 3,3′-iminobis(N,N-dimethylpropylamine), diisopropyltrimethyldiethylenetriamine, bis(dimethylaminopropyl)methylamine, trimethylaminoethylethanolamine, 3-dimethylamino-N,N-dimethylpropionamide, dimethylaminopropylamine, 1-(3-aminopropyl)pyrrolidine, 1-(2-aminoethyl)pyrrolidine, 1-(1-pyrrolidinyl)-2-propanamine. N,N-dimethyl-1-(pyrrolidin-1-yl)propan-2-amine, tris(dimethylaminopropyl)amine, N,N,N′N′-tetramethylethylenediamine, 1,3,5-tris(dimethylaminopropyl)hexahydrotriazine, N,N′-bis[3-(dimethylamino)propyl]urea, N-[3-(dimethylamino)propy]urea, 1,3-bis(dimethylamino)propane and N,N,N′N′-tetramethylhexamethylenediamine, and mixtures of the aforementioned amines are also usable. This means that it is preferably possible to use, for example, any single one of the aforementioned amines of group 1 or mixtures of the aforementioned amines of group 1. This is a preferred embodiment of the invention.

Additional tertiary amines which are usable with preference are also tertiary amines which satisfy the structural formula (III):

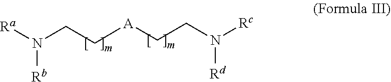

where
m is 1 or 2,
A is O, S or N—R^{e},
R^{a}, R^{b}, R^{c}, R^{d} and R^{e} are alkyl or functionalized alkyl having 1 to 20 carbons. The use of tertiary amines of the structural formula (III) is a preferred embodiment of the invention.

Further preferentially usable additional tertiary amines satisfy the following structural formula IV, V or VI:

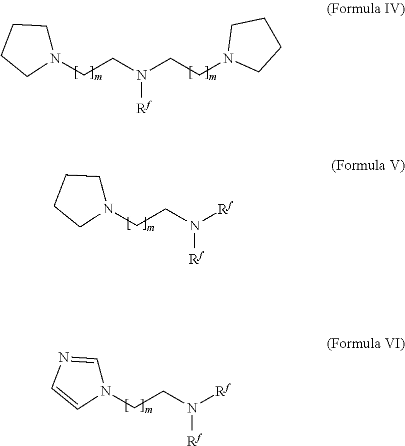

where
m is 1 or 2,
R^{f} is H, methyl, ethyl, isopropyl, 3-hydroxypropyl, 2-hydroxypropyl, hydroxyethyl, 3-aminopropyl, 2-aminopropyl or aminoethyl, where the two radicals may be different or identical. The use of amines of the structural formula IV, V or VI is a preferred embodiment of the invention. It is also possible here to use corresponding amine mixtures.

The tertiary amines, which are additionally usable, preferably as described above, especially selected from group 1 and/or formula III, IV, V or VI, have the function of acting as a catalyst, while the nitrogen-containing compounds mentioned further up, especially N,N,N′,N′-tetrakis(2-hydroxypropyl)ethylenediamine and/or N,N,N′,N′-tetrakis(2-hydroxyethyl)ethylenediamine, serve to further improve the solubility of the zinc salt.

A very particularly preferred composition according to the invention comprises additionally usable tertiary amine, preferably as described above, preferably selected from group 1 and or according to formula III, IV, V or VI, in amounts of 0.05% to 3% by weight, preferably of 0.1% to 2% by weight, based on the overall composition according to the invention.

A very particularly preferred composition according to the invention thus comprises zinc salt (preferably zinc(II) salt, especially zinc(II) carboxylate), carrier medium, nitrogen-containing compound, optionally, preferably obligatorily, supporting trimerization catalyst, and additional tertiary amine, preferably as described above, preferably selected from group 1 and/or according to formula III, IV, V or VI. It is preferable here that the additional tertiary amine is not part of the zinc-containing formulation.

A very particularly preferred composition according to the invention thus comprises (I) a zinc-containing formulation comprising zinc(II) salt, especially zinc(II) carboxylate, carrier medium and nitrogen-containing compound, preferably as described above, and as further constituents the preferred composition additionally comprises additional trimerization catalyst, preferably as described above, and additional tertiary amine, preferably as described above, preferably selected from group 1 and/or according to formula III, IV, V or VI.

In a further preferred embodiment of the invention, the compositions according to the invention additionally contain salts of amino acids and/or amino acid derivatives.

These salts of amino acids or amino acid derivatives are derivable in a formal sense from the reaction of aromatic carboxylic acids and amino acids; they are especially also obtainable by reaction of amino acids and aromatic carboxylic acids, aromatic carboxylic esters, aromatic carbonyl halides and/or aromatic carboxylic anhydrides, which is a preferred embodiment of the invention. The conversion to the salt can be undertaken here by the conventional methods, for example by reaction with the customary bases, for example KOH, NaOH or corresponding ammonium hydroxides.

Particularly preferred inventive salts of amino acid or amino acid derivatives satisfy the following formula (I):

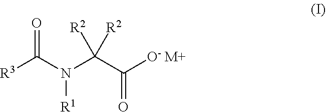

in which
R³ is an aromatic radical, optionally polycyclic aromatic radical, that may have substitutions, optionally also further carboxy functions to which further amino acids may be attached,
where R³ is preferably

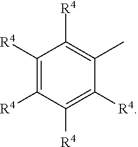

R¹, R², R³ are independently H, C₁ to C₁₈ alkyl, alkenyl, aryl or alkylaryl, which may also be substituted,
M⁺ is a cation, such as preferably alkali metal cation or ammonium cation or a substituted ammonium cation, preferably Li⁺, Na⁺, K⁺, Rb⁺, Cs⁺ or ammonium cation compounds such as advantageously tetraalkylammonium, trialkylhydroxyalylammonium, benzyltrialkylammonium, tetramethylammonium, tetraethylammonium, tetrabutylammonium, tetrapropylammonium, dimethyldiallylammonium, trimethyl(2-hydroxypropy)ammonium, triethyl(2-hydroxypropyl)ammonium, tripropyl(2-hydroxypropyl)ammonium, tributyl(2-hydroxypropyl)ammonium, dimethylbenzyl(2-hydroxypropyl)ammonium or dimethylbenzyl(2-hydroxyethyl)ammonium and combinations thereof.

It Is especially preferable here that R³ is phenyl, alkylphenyl, or is a radical that derives from phthalic acid, isophthalic acid, terephthalic acid or pyromellitic acid.

In a particularly preferred embodiment, the salts derive from amino acid derivatives of the following formula (II):

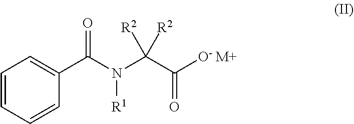

with
R¹, R², M⁺ as defined above, where preferably
R² are each H, where, more preferably,
R¹ and R² are each H, where, in particular,
R¹ and R² are each H and
M⁺ Is Na⁺, K⁺ or NR¹₄⁺,
R¹ as defined above.

Particularly preferred structures are accordingly:

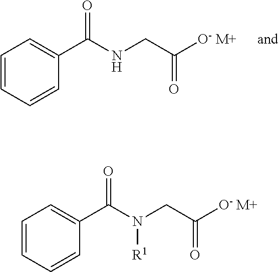

with
M⁺ and R¹ as defined above.

Particular preference is given to the salts of hippuric acid

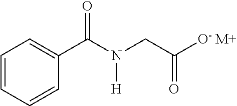

with
M⁺ as defined above, preferably sodium, potassium or ammonium as cation, especially preferably the sodium salt

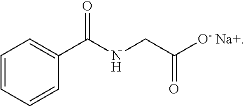

The salts usable in accordance with the invention can be prepared by the known methods.

Hippuric acid and its salts are commercially available. The preparation is known to the person skilled in the art. For example, hippuric acid can be prepared by reaction of benzoyl chloride with glycine (Schotten-Baumann method). Amidation on the basis of benzoic ester (methyl ester) and glycine is likewise possible. The preparation of the salts in that case is undertaken, for example, with the appropriate bases, for example KOH, NaOH or corresponding ammonium hydroxides.

A preferred composition according to the invention may comprise the additionally usable salts of amino acids and/or amino acid derivatives in amounts of 2% to 50% by weight, preferably of 4% to 45% by weight, based on the overall composition according to the invention.

Technical grade quality is often sufficient for use in PU or PIR foams since any secondary constituents from the preparation processes do not affect foam production. This is a further considerable advantage of the invention.

In a preferred embodiment of the invention, the salts of amino acids and/or amino acid derivatives can be added to the reaction mixture in a carrier medium. Carrier media used may be all substances suitable as solvent. Useful examples include glycols, alkoxylates or oils of synthetic and/or natural origin. The use of a carrier medium for the salts of amino acid derivatives is a preferred embodiment of the invention. The salts according to the invention may also be used as part of compositions with different carrier media.

In a preferred embodiment of the invention, the total proportion by mass of zinc-containing formulation according to the invention in the finished polyurethane foam is from 0.01% to 10% by weight, preferably from 0.1% to 5% by weight.

In a preferred embodiment of the invention, the composition according to the invention comprises water and/or blowing agents, optionally at least one flame retardant and/or further additives that are advantageously usable in the production of rigid polyurethane or polyisocyanurate foam. As well as the zinc-containing formulation according to the invention, it is also possible for further catalysts to be present.

A particularly preferred composition according to the invention contains the following constituents:
a) at least one isocyanate-reactive component, especially polyols,
b) at least one polyisocyanate and/or polyisocyanate prepolymer,
c) a catalyst according to the invention as described above (especially zinc-containing formulation according to the invention),
d) (optionally) further catalysts.
e) (optionally) a foam-stabilizing component based on siloxanes or other surfactants,
f) one or more blowing agents,
g) further additives, fillers, flame retardants, etc.

A preferred zinc-containing formulation that can be used in the context of this invention comprises, based on said formulation:
(i) zinc(II) carboxylate, preferably as defined above, in amounts of 2% to 50% by weight, preferably 5% to 45% by weight, more preferably 10% to 40% by weight,
(ii) carrier media, preferably as defined above, in amounts of 10% to 95% by weight, preferably 15% to 90% by weight, more preferably 20% to 70% by weight,
(iii) nitrogen-containing compound, preferably as defined above, in amounts of 1% to 70% by weight, preferably 2% to 60% by weight, more preferably 5% to 30% by weight,
% by weight each based on this overall zinc-containing formulation.

A particularly preferred zinc-containing formulation that can be used in the context of this invention comprises, based on said formulation:
(i) zinc(II) carboxylate, preferably as defined above, in amounts of 2% to 50% by weight, preferably 5% to 45% by weight, more preferably 10% to 40% by weight,
(ii) carrier media, preferably as defined above, in amounts of 10% to 95% by weight, preferably 15% to 90% by weight, more preferably 20% to 70% by weight,
(iii) nitrogen-containing compound, preferably as defined above. In amounts of 1% to 70% by weight, preferably 2% to 60% by weight, more preferably 5% to 30% by weight,
(iv) additional trimerization catalysts, as defined above, in amounts of 5% to 75% by weight, preferably 10% to 70% by weight, more preferably 15% to 60% by weight,
% by weight each based on this overall zinc-containing formulation.

A very particularly preferred composition according to the invention comprises the zinc-containing formulation just specified and also additional tertiary amine, preferably as defined above, preferably selected from group 1 and/or formula III, IV, V or VI.

The invention further provides a process for producing rigid polyurethane or polyisocyanurate foam by reacting one or more polyol components with one or more isocyanate components, wherein the reaction is effected in the presence or a catalyst that catalyses the formation of a urethane or isocyanurate bond, wherein the catalyst comprises zinc salts and/or a zinc-containing formulation, especially as described above, preferably using a composition according to the invention as described above. It is also possible here to use further catalysts in addition to the zinc-containing formulation according to the invention.

It is preferable here that the zinc-containing formulations are supplied to the reaction mixture for production of the rigid PU or PIR foam in a carrier medium, preferably comprising glycols, alkoxylates or oils of synthetic and/or natural origin.

The Invention further provides for the use of zinc salts and/or zinc-containing formulations, especially using a composition according to the invention as described above, as catalyst in the production of rigid polyurethane or polyisocyanurate foams, preferably for improving the use properties of the rigid polyurethane or polyisocyanurate foam, especially for increasing the compression hardness of the rigid polyurethane or polyisocyanurate foam at an early juncture by comparison with rigid polyurethane or polyisocyanurate foams that have been produced without the zinc salts and/or zinc-containing formulations, with compression hardness determinable according to DIN EN ISO 844:2014-11.

The invention further provides a rigid polyurethane or polyisocyanurate foam obtainable by the process according to the invention as described above.

The present invention additionally provides for the use of rigid polyurethane or polyisocyanurate foams according to the invention for thermal insulation purposes, preferably as insulation boards and insulant, and also for cooling apparatuses that include a rigid polyurethane or polyisocyanurate foam according to the invention as insulating material.

Individual usable components (identified here as a) to g)) are described in more detail below. Component c) has already been described.

Polyols suitable as polyol component a) for the purposes of the present invention are all organic substances having two or more isocyanate-reactive groups, preferably OH groups, and also formulations thereof. Preferred polyols are all polyether polyols and/or polyester polyols and/or hydroxyl-containing aliphatic polycarbonates, especially polyether polycarbonate polyols, and/or polyols of natural origin, called “natural oil-based polyols” (NOPs), that are customarily used for production of polyurethane systems, especially polyurethane coatings, polyurethane elastomers or foams. The polyols typically have a functionality of 1.8 to 8 and number-average molecular weights within a range from 500 to 15 000. It is customary to employ polyols having OH values within a range from 10 to 1200 mg KOH/g.

It is possible to use polyether polyols. These can be prepared by known methods, for example by anionic polymerization of alkylene oxides in the presence of alkali metal hydroxides, alkali metal alkoxides or amines as catalysts and by addition of at least one starter molecule which preferably contains 2 or 3 reactive hydrogen atoms in bonded form, or by cationic polymerization of alkylene oxides in the presence of Lewis acids, for example antimony pentachloride or boron trifluoride etherate, or by double metal cyanide catalysis. Suitable alkylene oxides contain 2 to 4 carbon atoms in the alkylene radical. Examples are tetrahydrofuran, 1,3-propylene oxide, 1,2-butylene oxide and 2,3-butylene oxide; ethylene oxide and 1,2-propylene oxide are preferably used. The alkylene oxides may be used individually, cumulatively, in blocks, in alternation or as mixtures. Starter molecules used may in particular be compounds having at least 2, preferably 2 to 8, hydroxyl groups, or having at least two primary amino groups in the molecule. Starter molecules used may, for example, be water, di-, tri- or tetrahydric alcohols such as ethylene glycol, propane-1,2- and -1,3-diol, diethylene glycol, dipropylene glycol, glycerol, trimethylolpropane, pentaerythritol, castor oil, etc., higher polyfunctional polyols, especially sugar compounds, for example glucose, sorbitol, mannitol and sucrose, polyhydric phenols, resols, for example oligomeric condensation products of phenol and formaldehyde and Mannich condensates of phenols, formaldehyde and dialkanolamines, and also melamine, or amines such as aniline, EDA, TDA, MDA and PMDA, more preferably TDA and PMDA. The choice of suitable starter molecule depends on the respective field of application of the resulting polyether polyol in polyurethane production.

It is possible to use polyester polyols. These are based on esters of polybasic aliphatic or aromatic carboxylic acids, preferably having 2 to 12 carbon atoms. Examples of aliphatic carboxylic acids are succinic acid, glutaric acid, adipic acid, suberic acid, azelaic acid, sebacic acid, decanedicarboxylic acid, maleic acid and fumaric acid. Examples of aromatic carboxylic acids are phthalic acid, isophthalic acid, terephthalic acid and the isomeric naphthalenedicarboxylic acids. The polyester polyols are obtained by condensation of these polybasic carboxylic acids with polyhydric alcohols, preferably with diols or triols having 2 to 12, more preferably 2 to 6, carbon atoms, preferably trimethylolpropane and glycerol.

It is possible to use polyether carbonate polyols. These are polyols containing carbon dioxide in the bonded form of the carbonate. Since carbon dioxide is formed in large amounts as a by-product in many processes in the chemical industry, the use of carbon dioxide as comonomer in alkylene oxide polymerizations is of particular interest from a commercial viewpoint. Partial replacement of alkylene oxides in polyols with carbon dioxide has the potential to distinctly lower costs for the production of polyols. Moreover, the use of CO₂ as comonomer is very environmentally advantageous, since this reaction constitutes the conversion of a greenhouse gas into a polymer. The preparation of polyether polycarbonate polyols by addition of alkylene oxides and carbon dioxide to H-functional starter substances with the use of catalysts has long been known. Various catalyst systems may be employed here: The first generation was that or heterogeneous zinc or aluminium salts, as described, for example, In U.S. Pat. No. 3,900,424 or U.S. Pat. No. 3,953,383. In addition, mono- and binuclear metal complexes have been used successfully for copolymerization of CO₂ and alkylene oxides (WO 2010/028382, WO 2009/130470, WO 2013/022932 or WO 2011/163133). The most important class of catalyst systems for the copolymerization of carbon dioxide and alkylene oxides is that of double metal cyanide catalysts, also referred to as DMC catalysts (U.S. Pat. No. 4,500,704, WO 2008/058913). Suitable alkylene oxides and H-functional starter substances are those also used for preparing carbonate-free polyether polyols, as described above.

It Is possible to use polyols based on renewable raw materials, “natural oil-based polyols” (NOPs). NOPs for production of polyurethane foams are of increasing interest with regard to the limited availability in the long term of fossil resources, namely oil, coal and gas, and against the background of rising crude oil prices, and have already been described many times in such applications (WO 2005/033167; US 2006/0293400, WO 2006/094227, WO 2004/096882, US 2002/0103091, WO 2006/118458 and EP 1678232). A number of such polyols are now available on the market from various manufacturers (WO2004/020497, US2006/0229375, WO2009/058387). Depending on the base raw material (e.g. soybean oil, palm oil or castor oil) and subsequent processing, polyols having a varying property profile are obtained. A distinction may essentially be made between two groups: a) polyols based on renewable raw materials that are modified such that they may be used to an extent of 100% in the production of polyurethanes (WO2004/020497, US2006/0229375); b) polyols based on renewable raw materials that on account of their processing and properties are able to replace the petrochemical-based polyol only up to a certain proportion (WO2009/058387).

A further class of usable polyols is that of “filled polyols” (polymer polyols). The characteristic feature of these is that they contain dispersed solid organic fillers up to a solids content of 40% or more. Usable polyols include SAN, PUD and PIPA polyols. SAN polyols are highly reactive polyols containing a dispersed copolymer based on styrene-acrylonitrile (SAN). PUD polyols are highly reactive polyols containing polyurea, likewise in dispersed form. PIPA polyols are highly reactive polyols containing a dispersed polyurethane, for example formed by in situ reaction of an isocyanate with an alkanolamine in a conventional polyol.

Preference is given to using polyols having a molar mass of less than 1000 g/mol. Preference is further given the polyols having a functionality or less than 3. In particular, it is preferable to use no triols having molar masses exceeding 1000 g/mol. Each of these is a particularly preferred form of the invention.

A preferred ratio of isocyanate and polyol, expressed as the index of the formulation, i.e. as the stoichiometric ratio of isocyanate groups to isocyanate-reactive groups (e.g. OH groups, NH groups) multiplied by 100, is within a range from 10 to 1000, preferably 40 to 700, more preferably 60 to 600, especially preferably 150 to 550. A further-preferred range is 250 to 500 and even further preferably 300 to 450.

An index or 100 represents a molar ratio of reactive groups of 1:1.

Preference is given in accordance with the invention to PIR formulations based on at least 70%, 80% or 90% polyester in the polyol component.

In a particularly preferred embodiment, polyester polyols based on aromatic carboxylic acids are used at more than 50 pphp, preferably more than 70 pphp, based on 100 parts by mass of polyol component.

Preferred aromatic polyester polyols have OH numbers in the range from 150 to 400 mg KOH/g, preferably 170 to 350, most preferably 180 to 300 mg KOH/g.

Isocyanate components b) used are preferably one or more organic polyisocyanates having two or more isocyanate functions. The polyol components used are preferably one or more polyols having two or more isocyanate-reactive groups.

Isocyanates suitable as isocyanate components are for the purposes of the present invention all isocyanates containing at least two isocyanate groups. It is generally possible to use all aliphatic, cycloaliphatic, arylaliphatic and preferably aromatic polyfunctional isocyanates known per se. Isocyanates are more preferably used in a range or from 60 to 200 mol %, relative to the sum total of isocyanate-consuming components.

Specific examples here are alkylene diisocyanates having 4 to 12 carbon atoms in the alkylene radical, e.g. dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate (HMDI), cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (isophorone diisocyanate or IPDI for short), hexahydrotoluene 2,4- and 2,6-diisocyanate and also the corresponding isomer mixtures, and preferably aromatic diisocyanates and polyisocyanates, for example toluene 2,4- and 2,6-diisocyanate (TDI) and the corresponding isomer mixtures, naphthalene diisocyanate, diethyltoluene diisocyanate, mixtures or diphenylmethane 2,4′- and 2,2′-diisocyanates (MDI) and polyphenylpolymethylene polyisocyanates (crude MDI) and mixtures of crude MDI and tolylene diisocyanates (TDI). The organic diisocyanates and polyisocyanates may be used individually or In the form of mixtures thereof. It is likewise possible to use corresponding “oligomers” of the diisocyanates (IPDI trimer based on isocyanurate, biurets, uretdiones). In addition, the use of prepolymers based on the abovementioned isocyanates Is possible.

It is also possible to use isocyanates which have been modified by the incorporation of urethane, uretdione. Isocyanurate, allophanate and other groups, called modified isocyanates.

Organic polyisocyanates that are particularly suitable and therefore employed with particular preference are various isomers of tolylene diisocyanate (tolylene 2,4- and 2,6-diisocyanate (TDI), in pure form or as isomer mixtures of varying composition), diphenylmethane 4,4′-diisocyanate (MDI), “crude MDI” or “polymeric MDI” (containing the 4,4′ isomer and also the 2,4′ and 2,2′ isomers of MDI and products having more than two rings) and also the two-ring product referred to as “pure MDI that is composed predominantly of 2,4′ and 4,4′ isomer mixtures, and prepolymers derived therefrom. Examples of particularly suitable isocyanates are detailed, for example, in EP 1712578, EP 1161474, WO 00/58383, US 2007/0072951, EP 1678232 and WO 2005/085310, which are hereby fully incorporated by reference.

Optional catalysts d) may be used in addition to the catalyst according to the invention, i.e. the zinc salts and/or zinc-containing formulations as described above.

Suitable additional optional catalysts d) in the context of the present invention are all compounds capable of accelerating the reaction of isocyanates with OH functions, NH functions or other isocyanate-reactive groups and with isocyanates themselves. It is possible here to make use of the customary catalysts known from the prior art, including, for example, amines (cyclic, acyclic; monoamines, diamines, oligomers having one or more amino groups), ammonium compounds, organometallic compounds and metal salts, preferably those of potassium, tin, iron, bismuth. In particular, it is possible to use as catalysts mixtures of more than one component.

As component e) it is possible to use SI-free surfactants or else organomodified siloxanes.

The use of such substances in rigid foams is known. In the context of this invention, it is possible here to use all compounds that assist foam production (stabilization, cell regulation, cell opening, etc.). These compounds are sufficiently well known from the prior art.

Corresponding siloxanes usable in the context of this invention are described, for example, in the following patent specifications: CN 103685385, CN 103857518, CN 103055759, CN 103044887, US 2008/0125503, US 2015/0057384. EP 1520870 A1, EP 1211279, EP 0887484. EP 0887465, EP 0275583. The abovementioned documents are hereby incorporated by reference and are considered to form part of the disclosure-content of the present invention. The use of polyether-modified siloxanes is particularly preferred.

The use of blowing agents f) Is optional, according to which foaming process is used. It is possible to work with chemical and physical blowing agents. The choice of blowing agent here is strongly dependent on the nature of the system.

In a particularly preferred embodiment, no HFOs are used as blowing agent.

Depending on the amount of blowing agent used, a foam having high or low density is produced. For instance, foams having densities of 5 kg/m³ to 900 kg/m³ can be produced. Preferred densities are 8 to 800, more preferably 10 to 600 kg/m³, especially 30 to 150 kg/m³.

Physical blowing agents used may be corresponding compounds having appropriate boiling points. It is likewise possible to use chemical blowing agents which react with NCO groups to liberate gases, for example water or formic acid. Examples of blowing agents include liquefied CO2, nitrogen, air, volatile liquids, for example hydrocarbons having 3, 4 or 5 carbon atoms, preferably cyclopentane, isopentane and n-pentane, hydrofluorocarbons, preferably HFC 245fa, HFC 134a or HFC 365mfc, chlorofluorocarbons, preferably HCFC 141b, hydrofluoroolefins (HFO) or hydrohaloolefins, for example 1234ze, 1234yf, 1233zd(E) or 1336mzz, oxygen-containing compounds such as methyl formate, acetone and dimethoxymethane, or chlorinated hydrocarbons, preferably dichloromethane and 1,2-dichloroethane.

Suitable water contents for the purposes of this invention depend on whether or not one or more blowing agents are used in addition to the water. In the case of purely water-blown foams the values are preferably 1 to 20 pphp; when other blowing agents are used additionally the amount of water used is reduced to preferably 0.1 to 5 pphp.

Additives g) used may be any substances which are known from the prior art and are used in the production of polyurethanes, especially polyurethane foams, for example crosslinkers and chain extenders, stabilizers against oxidative degradation (known as antioxidants), flame retardants, surfactants, biocides, cell-refining additives, cell openers, solid fillers, antistatic additives, nucleating agents, thickeners, dyes, pigments, colour pastes, fragrances, emulsifiers, etc.

The process according to the invention for producing rigid PU or PIR foams can be conducted by the known methods, for example by manual mixing or preferably by means of foaming machines. If the process is carried out by using foaming machines, it is possible to use high-pressure or low-pressure machines. The process according to the invention can be carried out either batchwise or continuously.

A preferred rigid polyurethane or polyisocyanurate foam formulation in the context of this invention results in a foam density of 5 to 900 kg/m³ and preferably has the composition shown in Table 1.

TABLE 1
Composition of a preferred rigid polyurethane
or polyisocyanurate foam formulation

| | Proportion |
|---|---|
| Component | by weight |
| Polyol | 0.1 to 100 |
| Amine catalyst (totality of all amine-containing catalysts) | 0 to 5 |
| Optional additional catalysts | 0 to 10 |
| Inventive zinc-containing formulation | 0.1 to 10 |
| Foam stabilizer (Si-free or Si-containing) | 0 to 5 |
| Water | 0.01 to 20 |
| Blowing agent | 0 to 40 |
| Further additives (flame retardants, etc.) | 0 to 90 |
| Isocyanate index: 10 to 1000 | |

For further preferred embodiments and configurations of the process of the invention, reference is also made to the details already given above in connection with the composition of the invention.

As already mentioned, the invention further provides a rigid PU or PIR foam obtainable by the process mentioned.

Rigid PU or PIR foam is a fixed technical term. The known and fundamental difference between flexible foam and rigid foam is that flexible foam shows elastic characteristics and hence deformation is reversible. By contrast, rigid foam is permanently deformed. In the context of the present invention, rigid PU or PIR foam is especially understood to mean a foam to DIN 7728:1982-05 that has a compressive strength to DIN 53 421/DIN EN ISO 604:2003-12 of advantageously ≥20 kPa, by preference ≥80 kPa, preferably ≥100 kPa, more preferably ≥150 kPa, particularly preferably ≥180 kPa. In addition, the rigid PU or PIR foam, according to DIN EN ISO 45902016-12, advantageously has a closed-cel content of greater than 50%, preferably greater than 80% and particularly preferably greater than 90%.

In a preferred embodiment of the invention, the polyurethane foam has a density of preferably 5 to 900 kg/m³, more preferably 8 to 800, especially preferably 10 to 600 kg/m³, more particularly 30 to 150 kg/m³.

It Is especially possible to produce predominantly closed-cell foams. The closed cel content is advantageously >80%, preferably >90%.

The rigid PU or PIR foams according to the invention can be used as or for production of insulation materials, preferably insulating panels, refrigerators, insulating foams, roof liners, packaging foams or spray foams.

The PU or PIR foams according to the invention can be used advantageously particularly in the refrigerated warehouse, refrigeration appliances and domestic appliances industry, for example for production of insulating panels for roofs and walls, as insulating material in containers and warehouses for frozen goods, and for refrigeration and freezing appliances.

Further preferred fields of use are in vehicle construction, especially for production of vehicle inner roof liners, bodywork parts, interior trim, cooled vehicles, large containers, transport pallets, packaging laminates, in the furniture industry, for example for furniture parts, doors, linings, in electronics applications.

Cooling apparatuses of the invention have, as insulation material, a PU or PIR foam according to the invention (polyurethane or polyisocyanurate foam).

The invention further provides for the use of the rigid PU or PIR foam as insulation material in refrigeration technology, in refrigeration equipment, in the construction sector, automobile sector, shipbuilding sector and/or electronics sector, as insulating panels, as spray foam, as one-component foam.

The subject matter of the invention has been described above and is described by way of example hereinafter, without any intention that the invention be restricted to these illustrative embodiments. Where ranges, general formulas or classes of compounds are stated, these are intended to encompass not only the corresponding ranges or groups of compounds explicitly mentioned but also all subranges and subgroups of compounds that can be obtained by removing individual values (ranges) or compounds. Where documents are cited in the context of the present description, the entire content thereof, particularly with regard to the subject matter that forms the context in which the document has been cited, is fully incorporated into the disclosure content of the present invention. Unless otherwise stated, percentages are in percent by weight. Where average values are stated, these are weight averages unless otherwise stated. Where parameters that have been determined by measurement are stated, the measurements have been carried out at a temperature of 25° C. and a pressure of 101325 Pa, unless otherwise stated.

The examples that follow describe the present invention by way of example, without any intention that the invention, the scope of application of which is apparent from the entirety of the description and the claims, be restricted to the embodiments specified in the examples.

### EXAMPLES

Foams were produced using the following raw materials:
Stepanpol® PS 2352: polyester polyol from Stepan
Daltolac® R 471: polyether polyol from Huntsman
TCPP: tris(2-chloroisopropy)phosphate from ICL
KOSMOS® 75 from Evonik Operations GmbH, catalyst based on potassium octoate
KOSMOS® 45 MEG from Evonik Operations GmbH, catalyst based on potassium octoate
POLYCAT® 5 from Evonik Operations GmbH, amine catalyst
POLYCAT® DP from Evonik Operations GmbH, amine catalyst
POLYCAT® 9 from Evonik Operations GmbH, amine catalyst
POLYCATO 206 from Evonik Operations GmbH, amine catalyst
POLYCAT® 77 from Evonik Operations GmbH, amine catalyst
TEGOAMIN® BDE from Evonik Operations GmbH, amine catalyst
DABCO® T from Evonik Operations GmbH, amine catalyst
DABCO® NE 300 from Evonik Operations GmbH, amine catalyst
DABCO® TMR 31 from Evonik Operations GmbH, catalyst for final curing
MDI (44V20): Desmodur® 44V20L from Covestro, diphenylmethane 4,4′-diisocyanate (MDI) with Isomeric and higher-functionality homologues
Tegostab® B 8460 from Evonik Operations GmbH, foam-stabilizing surfactant
   Production of the Zinc-Containing Formulations According to the invention:

Various components are produced, which can then be combined in the foaming operations to give inventive (or noninventive) compositions.

The components/compositions according to the invention may be added in preformulated form or as individual components to the reaction mixture to be foamed.

Inventive examples are those containing zinc.

### Component A: Zinc Acetate-Based

Zinc acetate dihydrate, 12.5 g (obtainable from Sigma-Aldrich), was dissolved together with 15 g of N,N,N′,N′-tetrakis(2-hydroxypropyl)ethylenediamine in monoethylene glycol, with a content of 11% zinc acetate.

### Component B: Zinc Propionate-Based

Zinc propionate, 12 g (obtainable from Sigma-Aldrich), was dissolved together with 15 g of N,N,N′,N′-tetrakis(2-hydroxypropyl)ethylenediamine in monoethylene glycol, with a content of 12% zinc propionate.

Component C: zinc ricinoleate-based: Kosmos® 54 Evonik Operations GmbH.

Further Non-Zn-Containing Components that are Used in the Examples:

### Component D:

Sodium hippurate (obtainable from Sigma-Aldrich) was dissolved in monoethylene glycol to give a solution containing 25% sodium hippurate.

Component E: potassium acetate-based: Kosmos® 45 MEG from Evonik Operations GmbH.

### Component F: Potassium Propionate-Based:

Potassium propionate (obtainable from Sigma-Aldrich) was dissolved in monoethylene glycol to give a solution containing 30% potassium propionate.

Component G: potassium octoate-based: Kosmos® 75 from Evonik Operations GmbH.

Component H: potassium pivalate-based: DABCO® TMR 20 from Evonik Operations GmbH.

Component I: DABCO® TMR 31 from Evonik Operations GmbH.

### Examples

### Production of PU Foams:

Foaming was carried out by manual mixing. For this purpose, the compounds according to the invention, polyols, flame retardants, catalysts according to the invention or not according to the invention, water, siloxane surfactant and blowing agent were weighed into a beaker and mixed by means of a disc stirrer (diameter 6 cm) at 1000 rpm for 30 s. The beaker was reweighed to determine the amount of blowing agent that had evaporated during the mixing operation and this was replenished. Subsequently, the isocyanate (MDI) was added, and the reaction mixture was stirred with the stirrer described at 3000 rpm for 5 s.

The reaction mixtures were introduced into appropriate beakers having a diameter at the upper edge of 20 cm in order to obtain free-rise foams. The amount of the reaction mixture was chosen such that the tip of the foam dome at the end was 10 to 15 cm above the upper edge of the beaker.

During the foaming, the gel time was determined, in order to assess the influence of the catalysts on the speed of foaming.

After 3 minutes, the foam domes were cut off at the upper edge of the beaker, such that a round foam surface was obtained. The indentation hardnesses of the foams were determined at this surface.

### Method of Determining Indentation Hardness:

For this purpose, the force for indenting a die of diameter 4 cm into the foam was measured. The indentation forces were measured at indentation depth 5 mm. Measurement was effected after 4, 6, 8 and 10 minutes, indenting the die at 4 different points on the cut surface in a circular arrangement.

### Method of Determining Compression Hardness:

The compressive strengths of the foams are measured on cubic test specimens having an edge length of 5 cm in accordance with DIN EN ISO 844:2014-11 up to a compression of 10% (the maximum compressive stress occurring in this measuring range is reported).

Table 2 summarizes the foam formulations used (Form. 1 to Form. 9):

TABLE 2
Foam formulations (PIR and PUR)

| Formulation | Form. 1 | Form. 2 | Form. 3 | Form. 4 | Form. 5 |
|---|---|---|---|---|---|
| Daltolac ® R 471 | | | | | |
| PS 2352 | 100 | 100 | 100 | 100 | 100 |
| Trimer cat. (inv. cat.) | variable | variable | variable | variable | variable |
| POLYCAT ® 5 | 0.5 | | | | |
| POLYCAT ® 9 | | 0.55 | | | |
| POLYCAT ® 206 | | | 0.9 | | |
| POLYCAT ® 77 | | | | 0.65 | |
| TEGOAMIN ® BDE | | | | | 0.8 |
| Further cats. | variable | variable | variable | variable | variable |
| Tegostab ® B 8460 | 2 | 2 | 2 | 2 | 2 |
| TCPP | 15 | 15 | 15 | 15 | 15 |
| Water | 0.5 | 0.5 | 0.5 | 0.5 | 0.5 |
| n-Pentane | 14 | 14 | 14 | 14 | 14 |
| Cyclopentane | | | | | |
| MDI (44V20) | about 190 | about 190 | about 190 | about 190 | about 190 |
| Index | 255 | 255 | 255 | 255 | 255 |

| Formulation | Form. 6 | Form. 7 | Form. 8 | Form. 9 |
|---|---|---|---|---|
| Daltolac ® R 471 | | | 100 | 100 |
| PS 2352 | 100 | 100 | | |
| Trimer cat. (inv. cat.) | variable | variable | variable | variable |
| POLYCAT ® 5 | | | 2.1 | |
| POLYCAT ® DP | | | | 3.5 |
| DABCO ® T | 0.5 | | | |
| POLYCAT ® NE 300 | | 1.1 | | |
| Further cats. | variable | variable | variable | variable |
| Tegostab ® B 8460 | 2 | 2 | 1.4 | 1.4 |
| TCPP | 15 | 15 | | |
| Water | 0.5 | 0.5 | 2.5 | 2.5 |
| n-Pentane | 14 | 14 | | |
| Cyclopentane | | | 13 | 13 |
| MDI (44V20) | about 190 | about 190 | about 190 | about 190 |
| Index | 255 | 255 | 130 | 130 |

Foaming results with the trimerization catalysts according to the invention.

### Table 3:

Summary of the foaming experiments with various catalysts according to the invention and foam formulations.

What are reported are the components used (Cmp. A-I, inventive or not according to the composition), the dosage thereof in (Dos, pphp), the formulation used from Table 2, the gel time (GT) in seconds, and the indentation hardnesses in newtons after the time specified in minutes (after mixing with MDI).

The catalyst compositions without Zn are noninventive.

TABLE 3

| | | | | | Form. | | Force in N after time of | | | |
|---|---|---|---|---|---|---|---|---|---|---|
| Ex. | Cmp. | Dos. | Cmp. | Dos. | No. | GT/sec. | 4 min | 6 min | 8 min | 10 min |
| Comp. 1 | E | 1.1 | | | 1 | 58 | 191 | 338 | 433 | 478 |
| 1 | E | 1.1 | A | 2 | 1 | 68 | 178 | 359 | 425 | 478 |
| 2 | E | 1.5 | A | 2 | 1 | 58 | 243 | 401 | 460 | 501 |
| 3 | E | 1.1 | C | 2 | 1 | 65 | 221 | 356 | 420 | 455 |
| 4 | E | 1.4 | C | 2 | 1 | 58 | 237 | 402 | 446 | 480 |
| Comp. 2 | E | 0.65 | | | 1 | 79 | 58 | 148 | 255 | 350 |
| Comp. 3 | E | 0.65 | I | 2 | 1 | 52 | 193 | 324 | 406 | 464 |
| Comp. 4 | E | 1.3 | | | 1 | 53 | 204 | 345 | 335 | 463 |
| 5 | E | 1.85 | A | 2 | 1 | 51 | 260 | 360 | 392 | 434 |
| Comp. 5 | G | 0.7 | | | 1 | 79 | 42 | 111 | 200 | 289 |
| Comp. 6 | G | 0.7 | I | 2 | 1 | 58 | 214 | 316 | 419 | 452 |
| Comp. 7 | G | 1.4 | | | 1 | 59 | 227 | 319 | 406 | 448 |
| 6 | G | 2 | A | 2 | 1 | 57 | 271 | 365 | 431 | 453 |
| Comp. 8 | H | 0.7 | | | 1 | 73 | 51 | 159 | 258 | 358 |
| Comp. 9 | H | 0.7 | I | 2 | 1 | 52 | 230 | 355 | 451 | 503 |
| 7 | H | 0.7 | A | 2 | 1 | 91 | 114 | 254 | 362 | 449 |
| 8 | H | 2 | A | 2 | 1 | 52 | 287 | 400 | 482 | 544 |
| Comp. 10 | F | 0.7 | | | 1 | 76 | 48 | 107 | 177 | 218 |
| Comp. 11 | F | 0.7 | I | 2 | 1 | 48 | 161 | 264 | 366 | 389 |
| 9 | F | 0.7 | B | 2 | 1 | 74 | 109 | 240 | 329 | 368 |
| 10 | F | 1.4 | B | 2 | 1 | 54 | 179 | 298 | 351 | 385 |
| Comp. 12 | F | 0.7 | I | 2 | 1 | 59 | 172 | 295 | 385 | 448 |
| 11 | F | 1.6 | C | 2 | 1 | 59 | 236 | 353 | 420 | 441 |
| 12 | F | 1.4 | C; D | 1; 1 | 1 | 58 | 188 | 353 | 415 | 452 |
| Comp. 13 | G | 0.7 | I | 2 | 1 | 58 | 156 | 292 | 387 | 446 |
| 13 | G | 1.6 | C | 2 | 1 | 58 | 244 | 354 | 389 | 439 |
| Comp. 14 | E | 0.65 | I | 2 | 1 | 58 | 246 | 286 | 476 | 503 |
| 14 | E | 1.5 | C | 2 | 1 | 58 | 296 | 421 | 492 | 543 |
| 15 | E | 1.35 | C; D | 1; 1 | 1 | 58 | 269 | 410 | 492 | 536 |
| Comp. 15 | E | 0.7 | | | 2 | 74 | 70 | 168 | 248 | 347 |
| Comp. 16 | E | 0.7 | I | 2 | 2 | 54 | 197 | 316 | 378 | 419 |
| 16 | E | 0.7 | A | 2 | 2 | 67 | 98 | 236 | 361 | 424 |
| 17 | E | 1.4 | A | 2 | 2 | 47 | 220 | 352 | 406 | 442 |
| Comp. 17 | E | 0.7 | | | 3 | 77 | 75 | 176 | 271 | 357 |
| Comp. 18 | E | 0.7 | I | 2 | 3 | 59 | 179 | 305 | 374 | 403 |
| 18 | E | 0.7 | A | 2 | 3 | 80 | 112 | 268 | 333 | 378 |
| 19 | E | 1.4 | A | 2 | 3 | 59 | 209 | 314 | 377 | 422 |
| Comp. 19 | E | 0.7 | | | 4 | 76 | 58 | 150 | 236 | 331 |
| Comp. 20 | E | 0.7 | I | 2 | 4 | 54 | 170 | 306 | 392 | 442 |
| 20 | E | 0.7 | A | 2 | 4 | 68 | 107 | 240 | 330 | 399 |
| 21 | E | 1.4 | A | 2 | 4 | 49 | 209 | 357 | 406 | 443 |
| Comp. 21 | E | 0.7 | | | 5 | 74 | 68 | 179 | 267 | 355 |
| Comp. 22 | E | 0.7 | I | 2 | 5 | 51 | 173 | 297 | 373 | 414 |
| 22 | E | 0.7 | A | 2 | 5 | 82 | 92 | 226 | 335 | 391 |
| 23 | E | 1.4 | A | 2 | 5 | 58 | 205 | 317 | 380 | 405 |
| Comp. 23 | E | 1.5 | | | | 58 | 335 | 415 | 447 | 491 |
| 24 | E | 1.6 | C | 2 | 6 | 57 | 325 | 440 | 501 | 532 |
| 25 | E | 1.55 | C; D | 1; 1 | 6 | 58 | 324 | 428 | 490 | 533 |
| Comp. 24 | F | 1.25 | I | 2 | 6 | 58 | 315 | 398 | 476 | 523 |
| 26 | F | 1.85 | C | 2 | 6 | 58 | 293 | 428 | 491 | 546 |
| 27 | F | 1.85 | C; D | 1; 1 | 6 | 58 | 277 | 402 | 460 | 543 |
| Comp. 25 | w | 0.65 | | | 7 | 76 | 59 | 193 | 273 | 341 |
| Comp. 26 | E | 1.1 | | | 7 | 58 | 136 | 260 | 356 | 416 |
| 28 | E | 1.1 | A | 2 | 7 | 52 | 179 | 302 | 420 | 487 |
| 29 | E | 0.9 | A | 2 | 7 | 57 | 144 | 297 | 405 | 463 |
| Comp. 27 | | | | | 8 | 63 | 54 | 109 | 196 | 58 |
| 30 | | | B | 2 | 8 | 61 | 107 | 204 | 288 | 360 |
| Comp. 28 | | | | | 9 | 50 | 96 | 169 | 237 | 306 |
| 31 | | | C | 3 | 9 | 53 | 143 | 228 | 298 | 360 |
| Comp. 29 | | | | | 9 | 52 | 59 | 143 | 203 | 262 |
| 32 | | | B | 2 | 9 | 52 | 124 | 243 | 312 | 365 |

The foams according to the invention each show distinctly higher indentation hardnesses than the comparative examples.

It is clear from this that the trimerization catalysts according to the invention enable an improvement in curing of the foam. It is even possible here in some cases to prolong the gel times, or to further improve the positive effects on through-curing with equal gel times.

This is an enormous advantage since, by virtue of the minor influence on gel time, the processability of the reaction mixture is maintained, for example with regard to the flowability of the foaming mixture, and the curing of the foam is simultaneously accelerated.

It is clearly apparent from the experiments that the trimerization catalysts according to the invention lead to improved curing of the foam. The very good results described above for the indentation hardnesses of the foams according to the invention correspond to those for compression hardness.

1: A composition for production of rigid polyurethane or polyisocyanurate foam, comprising at least:
an isocyanate component,
a polyol component,
optionally, a foam stabilizer,
optionally, blowing agent, and
at least one catalyst that catalyses the formation of a urethane or isocyanurate bond,
wherein said at least one catalyst comprises zinc salts and/or a zinc-containing formulation.

2: The composition according to claim 1, wherein the zinc salts and/or the zinc-containing formulation comprise zinc(II) salts.

3: The composition according to claim 2, wherein the zinc(II) salts are zinc(II) carboxylates, and wherein the zinc(II) carboxylates used are in stoichiometric form, meaning that Zn and carboxylates are present in a molar ratio of 1:2.

4: The composition according to claim 1, wherein the zinc-containing formulation comprises zinc salts in a carrier medium.

5: The composition according to claim 1, wherein the composition further comprises at least one nitrogen-containing compound.

6: The composition according to claim 1, wherein the composition further comprises at least one additional trimerization catalyst.

7: The composition according to claim 1, wherein the composition further comprises salts of amino acids and/or amino acid derivatives, which are derivable from a reaction of aromatic carboxylic acids and amino acids.

8: The composition according to claim 1, wherein the composition further comprises a tertiary amine as a further catalyst.

9: The composition according to claim 1, wherein a total proportion by mass of the zinc-containing formulation in a finished polyurethane foam is from 0.01% to 10% by weight.

10: The composition according to claim 1, wherein the zinc-containing formulation comprises:
(i) zinc(II) carboxylate, in amounts of 2% to 50% by weight,
(ii) carrier media in amounts of 10% to 95% by weight, and
(iii) a nitrogen-containing compound, in amounts of 1% to 70% by weight,
wherein % by weight is based on this overall zinc-containing formulation.

11: The composition according to claim 1, wherein the composition comprises:
the zinc-containing formulation which comprises zinc(II) salt, carrier medium, and a nitrogen-containing compound, and
as further constituents the composition additionally comprises
(i) an additional trimerization catalyst, and
(ii) an additional tertiary amine.

12: The composition according to claim 1, wherein the composition additionally comprises water and/or the blowing agent, optionally at least one flame retardant, and/or further additives that are usable advantageously in the production of the rigid polyurethane or polyisocyanurate foam.

13: A process for producing rigid polyurethane or polyisocyanurate foam, the process comprising:
reacting one or more polyol components with one or more isocyanate components, wherein the reaction is effected in the presence of a catalyst that catalyses the formation of a urethane or isocyanurate bond,
wherein said catalyst comprises zinc salts and/or a zinc-containing formulation.

14: A method for increasing the compression hardness of a rigid polyurethane or polyisocyanurate foam at an early juncture by comparison with rigid polyurethane or polyisocyanurate foams that have been produced without zinc salts and/or zinc-containing formulations, the method comprising:
producing the rigid polyurethane or polyisocyanurate foam with the composition according to claim 1,
wherein compression hardness is determinable according to DIN EN ISO 844:2014-11.

15: A rigid polyurethane or polyisocyanurate foam, obtainable by the process according to claim 13.

16: An article, comprising the rigid polyurethane or polyisocyanurate foam according to claim 15,
wherein the article is an insulation board, insulant, or a cooling apparatus.

17: The composition according to claim 2, wherein the zinc(II) salts are selected from the group consisting of zinc(II) acetate, zinc(II) propionate, zinc(II) pivalate, zinc(II) 2-ethylhexanoate (zinc(II) octoate), zinc(II) isononanoate (zinc(II) 3,5,5-trimethylhexanoate), zinc(II) neodecanoate, zinc(II) ricinoleate, zinc(II) palmitate, zinc(II) stearate, zinc(II) oleate, zinc(II) laurate, zinc(II) naphthenate, zinc(II) benzoate, zinc(II) lactate, zinc(II) glycinate, zinc(II) hippurate, and zinc(II) citrate.

18: The composition according to claim 5, wherein the at least one nitrogen-containing compound is selected from the group consisting of N,N,N′,N′-tetrakis(2-hydroxypropyl)ethylenediamine, N,N,N′,N′-tetrakis(2-hydroxyethyl)ethylenediamine, 2-[[2-[2-(dimethylamino)ethoxy]ethyl]methylamino]ethanol, fatty amine ethoxylates, PEG-3 tallowaminopropylamine, PPG-3 tallowaminopropylamine, glycine, lysine, arginine, sarcosine, ethylenediaminetetraacetate, and ethylenediaminetriacetate cocoalkylacetamide.

19: The composition according to claim 6, wherein the at least one additional trimerization catalyst is a carboxylate of ammonium, potassium, and/or other alkali metals or alkaline earth metals.

20: The composition according to claim 8, wherein the tertiary amine is selected from the group consisting of pentamethyldiethylenetriamine, bis(2-dimethylaminoethyl) ether, tris(dimethylaminopropyl)amine, N-[2-[2-(dimethylamino)ethoxy]ethyl]-N-methylpropane-1,3-diamine, 2-{[2-(dimethylamino)ethyl]methylamino}ethanol, 2-[[2-[2-(dimethyl-amino)ethoxy]ethyl]methylamino]ethanol, N-methyl-N—(N,N-dimethylaminopropyl)aminopropanol, N-methyl-N—(N,N-dimethylaminopropyl)aminoethanol, 1-bis[3-(dimethylamino)propyl]amino]-2-propanol, 1,1′-[[3-(dimethylamino)propyl]amino]-2-propanol, 3,3′-iminobis(N,N-dimethylpropylamine), diisopropyltrimethyldiethylenetriamine, bis(dimethylaminopropyl)methylamine, trimethylaminoethylethanolamine, 3-dimethylamino-N,N-dimethylpropionamide, dimethylaminopropylamine, 1-(3-aminopropyl)pyrrolidine, 1-(2-aminoethyl)pyrrolidine, 1-(1-pyrrolidinyl)-2-propanamine, N,N-dimethyl-1-(pyrrolidin-1-yl)propan-2-amine, tris(dimethylaminopropyl)amine, N,N,N′N′-tetramethylethylenediamine, 1,3,5-tris(dimethylaminopropyl)hexahydrotriazine, N,N′-bis[3-(dimethylamino)propyl]urea, N-[3-(dimethylamino)propyl]urea, 1,3-bis(dimethylamino)propane and N,N,N′N′-tetramethylhexamethylenediamine, and mixtures thereof;
or
wherein the tertiary amine satisfies the structural formula (III): 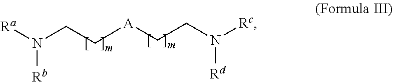
wherein
m is 1 or 2,
A is O, S, or N—R^{e}, and
R^{a}, R^{b}, R^{c}, R^{d}, and R^{e} are alkyl or functionalized alkyl having 1 to 20 carbons;
or
wherein the tertiary amine satisfies the structural formula IV, V, or VI: 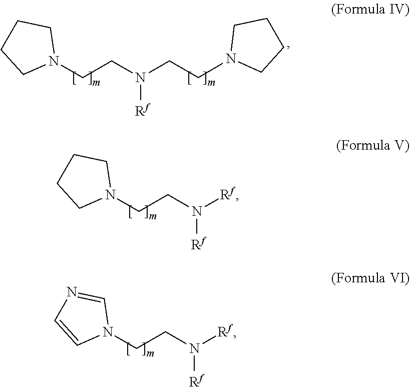
wherein
m is 1 or 2, and
R^{f} is H, methyl, ethyl, isopropyl, 3-hydroxypropyl, 2-hydroxypropyl, hydroxyethyl, 3-aminopropyl, 2-aminopropyl or aminoethyl, where the two radicals may be different or identical.
